(19) United States
(12) Patent Application Publication
(10) Pub. No.: US 2016/0202112 A1
(43) Pub. Date: Jul. 14, 2016

(54) SIGNAL LEVEL DETECTION DEVICE AND SIGNAL LEVEL DETECTION METHOD

(71) Applicant: KYB Corporation, Tokyo (JP)

(72) Inventors: Tomoo KUBOTA, Kanagawa (JP); Masatoshi OKUMURA, Gifu (JP)

(73) Assignee: KYB Corporation, Tokyo (JP)

(21) Appl. No.: 14/912,629

(22) PCT Filed: Jul. 16, 2014
(86) PCT No.: PCT/JP2014/068869

§ 371 Date: Feb. 18, 2016

(30) Foreign Application Priority Data
Sep. 17, 2013 (JP) 2013-192086

(51) Int. Cl. G01H 1/00

(52) U.S. Cl. CPC G01H 1/00

(57) ABSTRACT

A signal level detection device includes a signal generation unit configured to generate a plurality of level calculation signals that are out of phase with one another by using an input original signal, and a signal level computation unit configured to obtain the signal level based on the original signal and two or more of the level calculation signals, or based on three or more of the level calculation signals.

### TECHNICAL FIELD

The present invention relates to a signal level detection device and a signal level detection method.

### BACKGROUND ART

There are methods for controlling a damping force of a damper interposed between a sprung member and an unsprung member of a vehicle, or a thrust force of an actuator. One example of such methods is a control method based on a skyhook control theory.

In order to perform skyhook control, a damping force or a thrust force that should be output from the damper or the actuator is obtained by multiplying the sprung velocity by a skyhook gain (skyhook damping coefficient), and the damper or the actuator is controlled to produce the obtained damping force or thrust force (see JP 6-247117A).

Furthermore, in some cases, control is performed to suppress the vibration of the unsprung member in addition to the vibration of the sprung member in the vehicle. In such cases, the unsprung acceleration is detected, the unsprung velocity is computed from the unsprung acceleration, and a thrust force for suppressing the vibration of the unsprung member is obtained by multiplying the unsprung velocity by a skyhook gain. Then, by adding this thrust force and a thrust force for suppressing the vibration of the sprung member, which is obtained in a manner similar to the aforementioned skyhook control, a thrust force that should be output from the actuator is obtained. In this way, the actuator exerts a thrust force for suppressing the sprung vibration and the unsprung vibration (see JP 2011-84164A).

### SUMMARY OF INVENTION

In the aforementioned control, both when suppressing the vibration of the sprung member and when suppressing the vibration of the unsprung member, control dependent on the velocity of the sprung member or the velocity of the unsprung member is performed, that is to say, control focusing only on the velocity is performed. Hence, no consideration is given to the magnitude of vibration. For this reason, there are cases in which vibration cannot be suppressed effectively.

In contrast, JP 2011-225040A discloses a technique to obtain the unsprung velocity, obtain a signal that is out of phase with the unsprung velocity by 90 degrees by applying filter processing to the unsprung velocity, obtain the square root of the sum of the squares of these unsprung velocity and signal as a sequential envelope waveform, and control a damping force of a damper based on the envelope waveform.

The envelope waveform obtained by processing the signal in the above manner is equivalent to a signal level representing the magnitude of the signal. Additionally, in control of the damping force of the damper, the signal level obtained by processing the signal in the above manner is equivalent to the magnitude of the vibration of the sprung member, and is useful as effective information for suppression of vibration.

Here, with respect to a signal with a preset frequency, a signal level can be obtained by obtaining an envelope waveform. However, in the case where the source of a signal is the vibration of the sprung member, the frequency of the signal changes as the vibration frequency changes. For this reason, with respect to an input signal with a variable frequency, a signal level cannot be obtained accurately, and application to control involving a reasonably wide control frequency bandwidth is difficult.

It is an object of the present invention to detect a signal level that is suitable for control involving a wide frequency bandwidth.

According to one aspect of the present invention, a signal level detection device, which detects a signal level representing a magnitude of a signal, includes a signal generation unit configured to generate a plurality of level calculation signals that are out of phase with one another by using an input original signal, and a signal level computation unit configured to obtain the signal level based on the original signal and two or more of the level calculation signals, or based on three or more of the level calculation signals.

According to another aspect of the present invention, a signal level detection method, which detects a signal level representing a magnitude of a signal, includes generating, from an original signal, a plurality of level calculation signals that are out of phase with one another, and obtaining the signal level based on the original signal and the plurality of level calculation signals, or based on the plurality of level calculation signals.

### BRIEF DESCRIPTION OF DRAWINGS

FIG. 1 shows a configuration of a signal level detection device according to an embodiment of the present invention.

FIG. 2 is an explanatory diagram showing a mass system.

FIG. 3 shows waveforms of level calculation signals.

FIG. 4 shows frequency-phase characteristics of the level calculation signals.

FIG. 5 shows waveforms of absolute values of the level calculation signals.

FIG. 6 shows waveforms of absolute values of level calculation signals corresponding to an input original signal with a different frequency.

FIG. 7 shows a configuration of a signal level detection device according to a modification example.

FIG. 8 shows an example of frequency-phase characteristics of level calculation signals for obtaining a favorable signal level with respect to an original signal of 0.1 Hz to 20 Hz.

### DESCRIPTION OF EMBODIMENTS

The following describes an embodiment of the present invention with reference to the attached drawings.

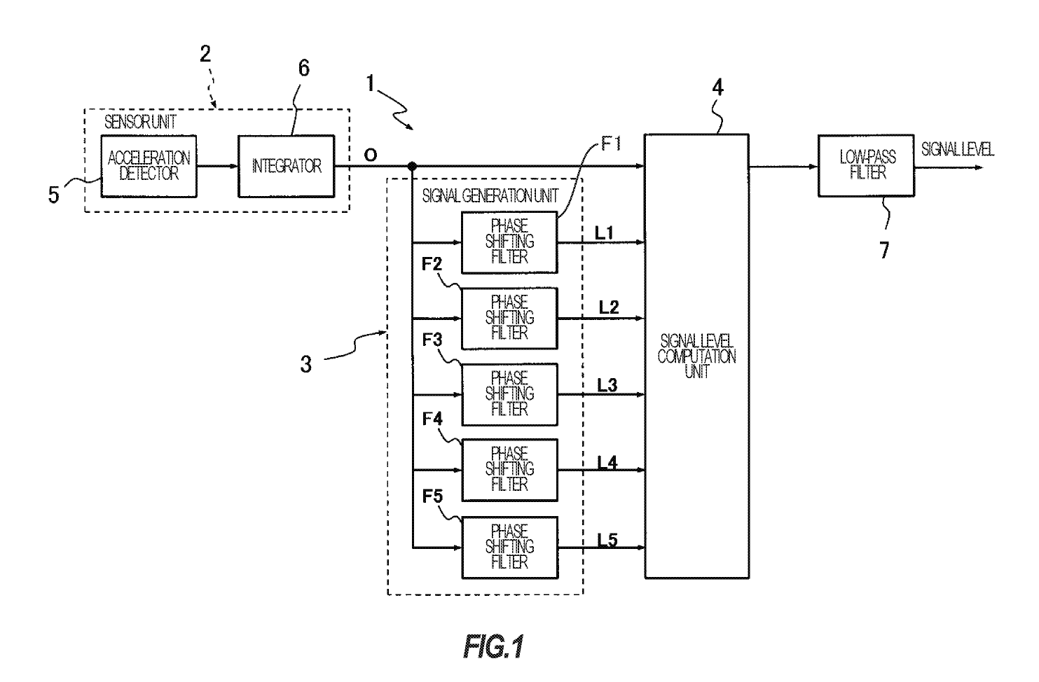

As shown in FIG. 1, a signal level detection device 1 is applied to a device that detects a signal level of a signal indicating the magnitude of the vibration of a mass M.

The signal level detection device 1 includes a signal generation unit 3 and a signal level computation unit 4. The signal generation unit 3 generates two or more level calculation signals that are out of phase with one another using an original signal O output from a sensor unit 2, which obtains the velocity of the mass M as vibration information. The signal level computation unit 4 obtains a signal level r based on the original signal O and the level calculation signals. In the present embodiment, the signal generation unit 3 generates five level calculation signals L1 to L5.

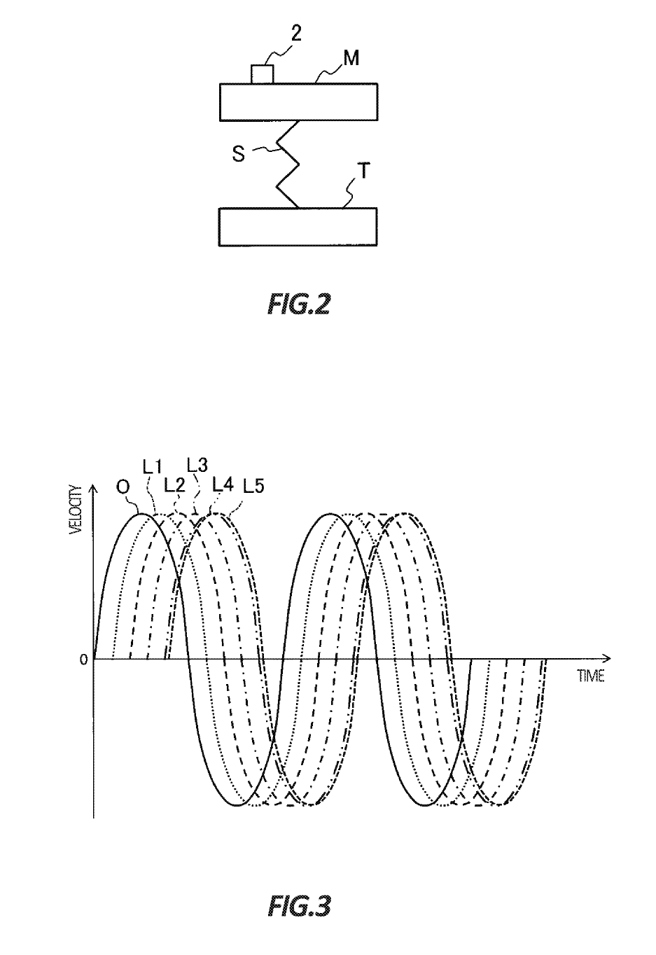

A description is now given of a case in which the sensor unit 2 senses the vibration information of the mass M that is elastically supported by a spring S, which is vertically attached to a base T, from a lower side as shown in FIG. 2, and the signal level detection device 1 detects a signal level from a signal output from the sensor unit 2.

The sensor unit 2 is attached to the mass M so as to detect the velocity of the mass M in the up-down direction. In order to detect a signal level with respect to a signal representing vibration information of the mass M in relation to the left-right direction, it is sufficient to detect the velocity of the mass M in the left-right direction with the sensor unit 2.

It is sufficient that the sensor unit 2 be able to detect the velocity in the direction of the vibration of the mass M. For example, in order to detect a signal level of a signal obtained by sensing the vibration of the mass M in the up-down direction and the vibration of the mass M in the left-right direction, the velocities in the two directions, that is to say, the up-down direction and the left-right direction may be obtained by detecting the velocities of the mass M in the direction other than the following directions with the sensor unit 2: the up-down direction, the left-right direction, and the direction penetrating the surface of the sheet of FIG. 2.

The signal level detection device 1 detects a signal level by processing a signal obtained from the sensor unit 2. Therefore, it goes without saying that the signal level detection device 1 can not only obtain a signal level from a signal obtained by sensing the vibration of the mass M, but also obtain a signal level through processing of a signal obtained by sensing a pressure fluctuation in a container, a change in the atmospheric pressure, radio waves, and the like.

The sensor unit 2 is composed of an acceleration detector 5 and an integrator 6. The acceleration detector 5 is attached to the mass M so as to detect the acceleration of the mass M in the up-down direction. The integrator 6 obtains the velocity of the mass M in the up-down direction by integrating the acceleration in the up-down direction detected by the acceleration detector 5. The sensor unit 2 outputs the detected velocity of the mass M in the up-down direction as the original signal O.

The signal generation unit 3 obtains five level calculation signals L1 to L5 that have the same amplitude as the original signal O and are out of phase with one another. Specifically, in order to obtain level calculation signals Ln (n=1, 2, 3, 4, 5) from the original signal O, the signal generation unit 3 includes phase shifting filters F1 to F5 that change only the phase of the original signal O while leaving the amplitude of the original signal O unchanged.

In the signal generation unit 3, the phase shifting filters F1 to F5 are arranged in parallel. The signal generation unit 3 applies filter processing to the original signal O using the phase shifting filters F1 to F5. It is sufficient that the phase shifting filters be provided in one-to-one correspondence with the level calculation signals. In the present case, it is sufficient to provide five phase shifting filters in correspondence with the level calculation signals L1 to L5.

A transfer function G(s) of the phase shifting filters F1 to F5 is set in accordance with the following expression (1). In expression (1), O(s) denotes the amount of Laplace transform of the original signal O, Ln(s) (n=1, 2, 3, 4, 5) denotes the amount of Laplace transform of the level calculation signals Ln (n=1, 2, 3, 4, 5), s denotes a Laplace operator, and ωn (n=1, 2, 3, 4, 5) denotes frequency. Here, different frequencies are set to ω1 to ω5.

$$\begin{matrix}[ Math 1 ] & \\ G ( s ) = \frac{Ln ( s )}{O ( s )} = \frac{- s + {ω}_{n}}{s + {ω}_{n}} & ( 1 )\end{matrix}$$

Therefore, the signal generation unit 3 obtains the level calculation signals Ln (n=1, 2, 3, 4, 5) from the original signal O using the phase shifting filters Fn (n=1, 2, 3, 4, 5) whose transfer function G(s) is set with a frequency of ωn (n=1, 2, 3, 4, 5).

For example, the signal generation unit 3 obtains the level calculation signal L4 from the original signal O by applying filter processing to the original signal O using the phase shifting filter F4 whose transfer function G(s) is set by inputting a frequency of ω4.

As set forth above, the signal generation unit 3 obtains the level calculation signals L1 to L5 using the phase shifting filters F1 to F5. In this way, five level calculation signals L1 to L5 that have the same amplitude and are out of phase with one another can easily be obtained with respect to the input original signal O with a certain frequency α, as shown in FIG. 3.

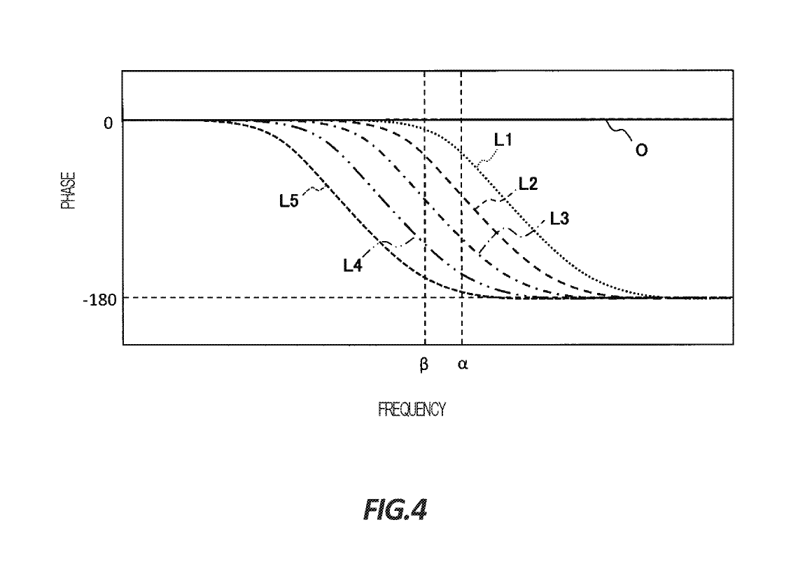

The phase difference between the original signal O and the level calculation signal L1, as well as the phase differences among the level calculation signals L1 to L4, is represented by an equal interval. However, the phase difference between the level calculation signal L4 and the level calculation signal L5 is different from the phase difference between the original signal O and the level calculation signal L1, and the phase differences among the level calculation signals L1 to L4. This is because, as shown in FIG. 4, the frequency-phase characteristics of the level calculation signals L1 to L4 exhibit changes in a range from an upper limit of 0 degrees to a lower limit of −180 degrees, that is to say, a restriction defined between 0 degrees and −180 degrees.

In the case where the original signal O has an extremely low frequency, the phase of the level calculation signals L1 to L5 is 0 degrees or in the vicinity of 0 degrees. In the case where the original signal O has an extremely high frequency, the phase of the level calculation signals L1 to L5 is −180 degrees or in the vicinity of −180 degrees. For this reason, as shown in FIG. 3, the phase differences among the level calculation signals L1 to L4 are represented by an equal interval, whereas the phase difference between the level calculation signal L5 and the adjacent level calculation signal L4 decreases towards a phase of −180 degrees.

The transfer function G(s) of the phase shifting filters F1 to F5 may also be set in accordance with the following expression (2). In expression (2), O(s) denotes the amount of Laplace transform of the original signal O, Ln(s) (n=1, 2, 3, 4, 5) denotes the amount of Laplace transform of the level calculation signals Ln (n=1, 2, 3, 4, 5), s denotes a Laplace operator, and ωn (n=1, 2, 3, 4, 5) denotes frequency. Here, different frequencies are set to ω1 to ω5.

$$\begin{matrix}[ Math 2 ] & \\ G ( s ) = \frac{Ln ( s )}{O ( s )} = \frac{s - {ω}_{n}}{s + {ω}_{n}} & ( 2 )\end{matrix}$$

The phase shifting filters F1 to F5 may also be second-order low-pass filters. Specifically, the transfer function G(s) of the phase shifting filters F1 to F5 may also be set in accordance with the following expression (3). In expression (3), O(s) denotes the amount of Laplace transform of the original signal O, Ln(s) (n=1, 2, 3, 4, 5) denotes the amount of Laplace transform of the level calculation signals Ln (n=1, 2, 3, 4, 5), s denotes a Laplace operator, ζ denotes a damping ratio, and ωn (n=1, 2, 3, 4, 5) denotes a cutoff frequency. Here, different cutoff frequencies are set to ω1 to ω5.

$$\begin{matrix}[ Math 3 ] & \\ G ( s ) = \frac{Ln ( s )}{O ( s )} = \frac{{ω}_{n}^{2}}{{s}^{2} + 2 {ζω}_{n} s + {ω}_{n}^{2}} & ( 3 )\end{matrix}$$

By using low-pass filters as the phase shifting filters F1 to F5, the level calculation signals L1 to L5 can be delayed in phase relative to the original signal O. On the other hand, by using high-pass filters as the phase shifting filters F1 to F5, the level calculation signals L1 to L5 can be advanced in phase relative to the original signal O. Therefore, it is possible to use a high-pass filter as a part of the phase shifting filters F1 to F5 and use a low-pass filter as the remaining part of the phase shifting filters F1 to F5.

The signal generation unit 3 obtains the level calculation signals L1 to L5 that are out of phase with one another from the original signal O. Therefore, instead of using the above-described filter processing, signals that are sequentially delayed relative to the original signal O by a prescribed time period may be generated as the level calculation signals L1 to L5.

The signal level computation unit 4 obtains the maximum value among signals yielded by applying absolute value processing to the original signal O and the level calculation signals L1 to L5.

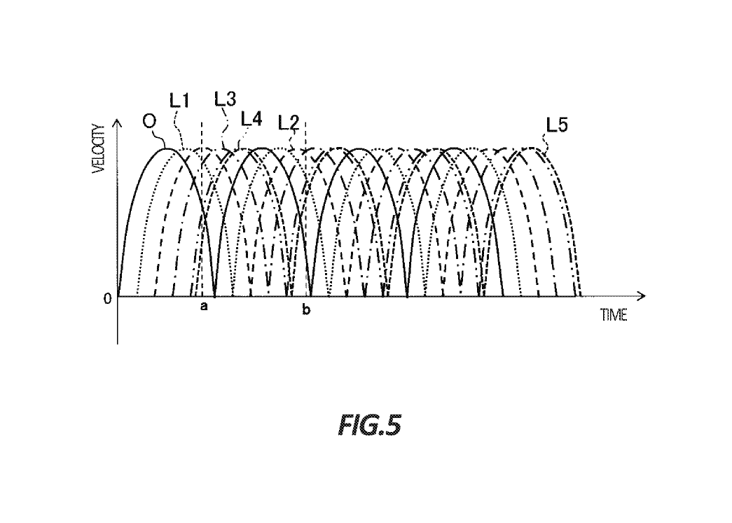

As a result of applying the absolute value processing to the original signal O and the level calculation signals L1 to L5, the post-processing original signal O and level calculation signals L1 to L5 have waveforms shown in FIG. 5, which are obtained by flipping negative parts of the waveforms of the original signal O and the level calculation signals L1 to L5 at the time axis towards the positive side.

The absolute values of the original signal O and the level calculation signals L1 to L5 are out of phase with one another. Therefore, after the absolute value processing has been applied to the original signal O and the level calculation signals L1 to L5, the waveforms of the post-processing original signal O and level calculation signals L1 to L5 have time lags.

As a result of such absolute value processing, as shown in FIG. 5, at any point in time, the maximum value among the post-processing original signal O and level calculation signals L1 to L5 equals or approximates the maximum amplitude of the original signal O.

For example, at time a, the maximum value among the post-processing original signal O and level calculation signals L1 to L5 is the maximum value of the level calculation signal L2. On the other hand, at time b, the maximum value among the post-processing original signal O and level calculation signals L1 to L5 approximates the value of the maximum amplitude of the original signal O.

The maximum amplitudes of the level calculation signals L1 to L5 are equal to the maximum amplitude of the original signal O in terms of velocity, and the maximum amplitude of the original signal O is equal to a signal level. In the present embodiment, the maximum amplitude of the original signal O represents the magnitude of the vibration of the mass M on the basis of velocity. That is to say, the maximum value obtained within one cycle of the original signal O serves as the signal level. However, the signal level cannot be obtained in a timely fashion by way of sampling within one cycle of the original signal O. In addition, if the frequency of the vibration of the mass M changes, the frequency of the original signal O changes, and a time period required for one cycle of the original signal O changes, which results in the failure to obtain the maximum amplitude.

In contrast, by generating the level calculation signals L1 to L5 that have the same amplitude as the original signal O and are out of phase with one another in the above-described manner, one of the original signal O and the level calculation signals L1 to L5 that have been subjected to the absolute value processing is expected to have the maximum value or a value close to the maximum value at the time of computing the signal level r. Therefore, by obtaining the maximum value among the original signal O and the level calculation signals L1 to L5 that have been subjected to the absolute value processing as the signal level r, the value of the obtained signal level r exactly equals or approximates the value of the maximum amplitude of the original signal O.

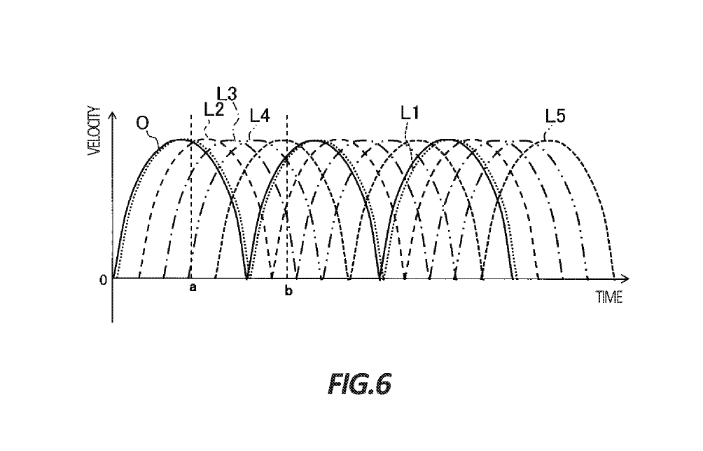

In this way, for example, even in the case where an original signal O with a frequency β, which is lower than the frequency α, has been input as shown in FIG. 6, the maximum value among the original signal O and the level calculation signals L1 to L5, which are out of phase with the original signal O, at the time of computation is obtained as the signal level r. Therefore, the value of the signal level r equals or approximates the value of the maximum amplitude of the original signal O. That is to say, even if the frequency of the original signal O changes, a value approximating the value of the maximum amplitude of the original signal O can be obtained as the signal level r.

In FIG. 6, while the phase differences among the level calculation signals L1 to L5 are represented by an equal interval, the phase difference between the original signal O and the level calculation signal L1 is different from the phase differences among the level calculation signals L1 to L5. This is because, as opposed to the fixed, 0-degree phase of the original signal O, the phase of the level calculation signal L1 is restricted by the upper limit of 0 degrees as the frequency lowers, as shown in FIG. 4. As a result, the phase of the level calculation signal L1 is close to 0 degrees, thereby reducing the phase difference between the level calculation signal L1 and the original signal O.

In a region with a frequency lower than the frequency β, the phase difference between the level calculation signal L1 and the adjacent level calculation signal L2 is also small. However, even in the case of a low frequency, a value approximating the value of the maximum amplitude of the original signal O can be obtained as the signal level r using the level calculation signals L2 to L5 whose phase differences are represented by an equal interval. In this way, even if the frequency of the original signal O changes, the signal level detection device 1 can obtain a value that equals or approximates the value of the maximum amplitude of the original signal O as the signal level r in real time and in a timely fashion. Hence, the signal level r can be obtained accurately with respect to a signal across wide frequency bands.

As described above, even if the frequency of the original signal O changes, the signal level detection device and a signal level detection method according to the present embodiment can obtain the signal level r in real-time and in a timely fashion. This enables detection of the signal level r suitable for control involving a wide frequency bandwidth.

Furthermore, in the present embodiment, the original signal O represents the vibration information of the mass M, which indicates a velocity. Therefore, by detecting the signal level r in the above-described manner, the magnitude of the vibration (vibration level) of the mass M can be detected in real time and in a timely fashion. The vibration level thus obtained has a small temporal delay relative to the vibration of the mass M, and is hence sufficiently sustainable when used in, for example, control for suppressing the vibration of a vehicle.

While the signal level r is obtained using the original signal O and the level calculation signals L1 to L5 in the present embodiment, the signal level r can be obtained accurately by generating, from the original signal O, three or more level calculation signals that are out of phase with one another in a frequency bandwidth in which the signal level r is desired to be obtained. Therefore, the signal level computation unit 4 may obtain the signal level r by carrying out the above-described procedure using only the level calculation signals without using the original signal O.

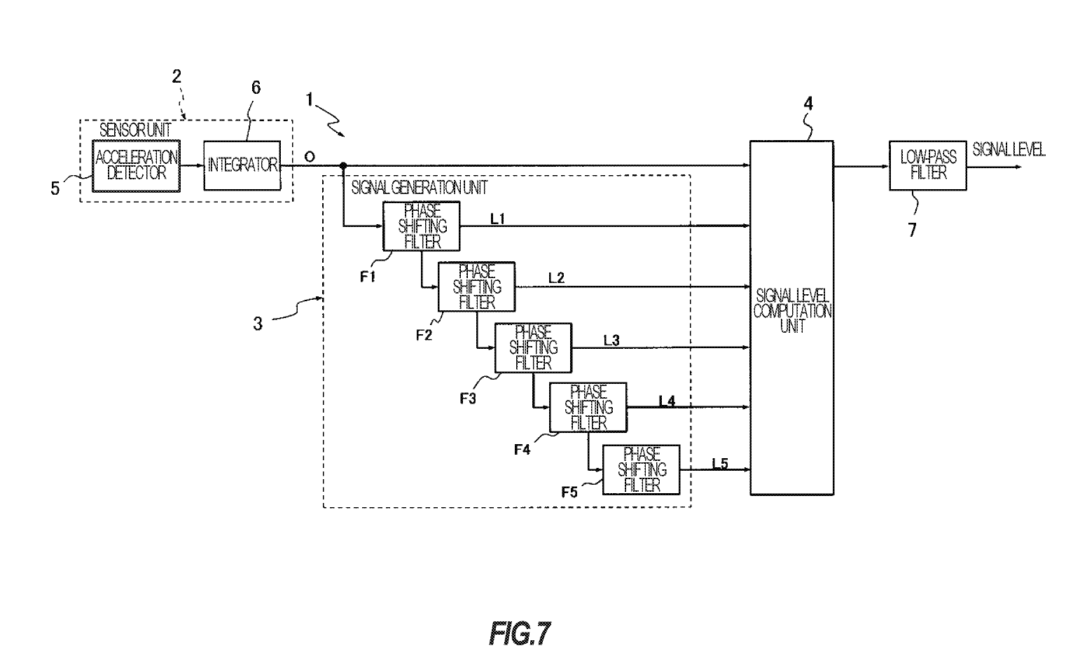

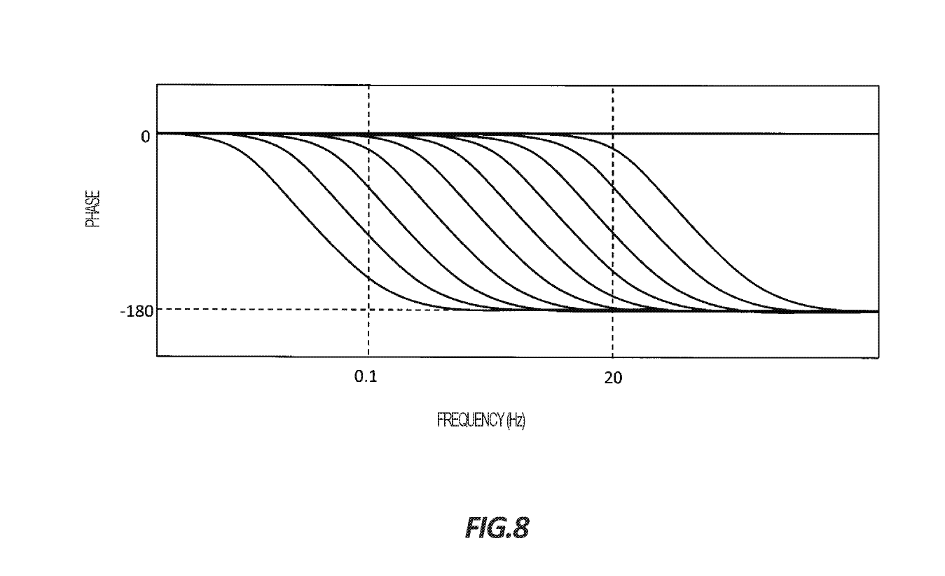

Furthermore, while the phase shifting filters F1 and F5 obtain the level calculation signals L1 to L5 by processing the original signal O in parallel, the phase shifting filters F1 to F5 may be arranged in series as shown in FIG. 7.

In this case, the level calculation signal L1 is obtained first by processing the original signal O using the phase shifting filter F1, the level calculation signal L2 is obtained next by processing the level calculation signal L1 using the phase shifting filter F2, and so on. In this way, a level calculation signal that has been processed using an immediately preceding phase shifting filter is processed using an immediately succeeding phase shifting filter to obtain a resultant level calculation signal.

Here, as shown in FIG. 4, the frequency-phase characteristics of the level calculation signals exhibit changes in the range from the upper limit of 0 degrees to the lower limit of −180 degrees. The level calculation signals approach 0 degrees in phase as they decrease in frequency and approach −180 degrees in phase as they increase in frequency. For this reason, at the high frequency α, the phase differences among the original signal O and the level calculation signals L1 to L4 are represented by an equal interval, and it is possible to obtain a signal level r with a value that equals or approximates the maximum amplitude of the original signal O. On the other hand, at the low frequency β, the phase differences among the level calculation signals L1 to L5 are represented by an equal interval, and the value of the obtained signal level r equals or approximates the maximum amplitude of the original signal O.

That is to say, the signal level detection device 1 according to the present embodiment can detect the signal level r accurately with respect to the original signal O in a range from the high frequency α to the low frequency β.

As set forth above, the original signal O and the level calculation signals L1 to L4 generated using the phase shifting filters F1 to F4 contribute to the detection of the signal level r with respect to the original signal O with the frequency α. On the other hand, the phase shifting filters F1 to F5 contribute to the detection of the signal level r with respect to the original signal O with the frequency β. It is apparent from the foregoing that the phase shifting filters contributing to the detection of the signal level r vary depending on the frequency of the original signal O.

In view of the above, the frequency bandwidth in which the signal level r can be detected accurately can be widened in the following manner. In the case where the original signal O is used together with the level calculation signals, it is sufficient to disperse the original signal O and at least two level calculation signals such that their phase differences are represented by an equal interval within a 180-degree phase range between a lower limit and an upper limit of a frequency bandwidth. On the other hand, in the case where the signal level is obtained using only the level calculation signals, it is sufficient to disperse at least three level calculation signals such that their phase differences are represented by an equal interval within a 180-degree phase range. It should be noted that it is sufficient to determine the number of filters provided to generate level calculation signals in accordance with the number of level calculation signals to be generated.

For example, in order to obtain the signal level r with respect to an input original signal in a bandwidth from 0.1 Hz to 20 Hz, it is sufficient to disperse three or more level calculation signals, or disperse the original signal and two or more level calculation signals, such that their phase differences are represented by an equal interval within a 180-degree phase range throughout the bandwidth from 0.1 Hz to 20 Hz, as shown in FIG. 8. In this way, the signal level r can be detected accurately with respect to the input original signal in the bandwidth from 0.1 Hz to 20 Hz.

Therefore, the signal level r can be detected with respect to a signal in wide frequency bands, and the accuracy is improved as well, by configuring the signal generation unit 3 to generate the level calculation signals L1 to L5 with respect to the input original signal O such that the original signal O and the level calculation signals L1 to L5, which contribute to the detection of the signal level r, are dispersed to have phase differences represented by an equal interval of 60 degrees or smaller within a 180-degree phase range.

This is because, provided that signals are represented by sine waves, if the signal level r is obtained by generating three level calculation signals that are out of phase with one another by 60 degrees, the signal level r does not fall below at least 0.85 times the wave height of the original signal O of the mass. In this way, a favorable signal level r can be obtained.

It should be noted that, in the case where the original signal O is used only in the generation of level calculation signals, the signal level r can be detected with respect to a signal in wide frequency bands, and the accuracy is improved as well, by configuring the signal generation unit 3 to generate the level calculation signals L1 to L5, which contribute to the detection of the signal level r, such that the level calculation signals L1 to L5 are dispersed with phase differences represented by an equal interval of 60 degrees or smaller within a 180-degree phase range.

Furthermore, in the case where a large number of level calculation signals are generated with respect to an input original signal O with a certain frequency such that the phase differences among the level calculation signals are represented by an equal interval within a 180-degree phase range and these phase differences among the level calculation signals are small, there is no practical problem in using the maximum value among the absolute values of the level calculation signals as the signal level r, using the second or third largest value thereamong as the signal level r, or using an average value of the maximum value and the second largest value thereamong as the signal level r.

For example, provided that signals are represented by sine waves, if 12 level calculation signals are generated such that they are out of phase with one another by 15 degrees, even when the third largest value among the absolute values of the level calculation signals is used as the signal level r, the signal level r does not fall below at least 0.9 times the wave height of the original signal O of the mass. Therefore, a favorable signal level r can be obtained. It should be noted that, in this case also, the maximum value among the absolute values of the level calculation signals is closest to the actual signal level r. It is therefore preferable to obtain the maximum value as the signal level r.

Also, by processing the signal level r output from the signal level computation unit 4 using a low-pass filter 7 as shown in FIG. 1, ripple can be removed from the obtained signal level r, and a sudden change in the signal level r can be suppressed.

Moreover, in the present embodiment, the absolute value processing is applied to the original signal O and the level calculation signals L1 to L5. Consequently, even in the case where the sign of the original signal O is negative, it is likely that the value of the signal level r approximates the maximum amplitude of the original signal O. Therefore, the signal level r can be detected with higher accuracy.

It is sufficient for the signal level detection device 1 to include, for example, the following hardware resources (not shown): an A/D converter for importing a signal output from the acceleration detector 5; a storage device, such as a read-only memory (ROM), that stores a program used in processing necessary for the detection of the signal level r; a computation device, such as a central processing unit (CPU), that executes processing based on the program; and a storage device, such as a random-access memory (RAM), that provides a storage area to the CPU. In this way, the signal level detection device 1 causes the CPU to execute the program, thereby enabling the operations of the signal generation unit 3 and the signal level computation unit 4.

Additionally, in the present embodiment, the signal level r is obtained using the velocity of the mass M as the original signal O. Therefore, the obtained signal level r represents a vibration level on the basis of the velocity of the mass M. In contrast, for example, if the vibration information of the mass M represents acceleration and the signal level r is obtained using the acceleration as the original signal O, a vibration level can be obtained on the basis of the acceleration. Similarly, if the vibration information of the mass M represents a displacement and the signal level r is obtained using the displacement as the original signal O, a vibration level can be obtained on the basis of the displacement.

Now, assume a case in which the signal level detection device 1 according to the present embodiment is applied to a vehicle, and a signal level is detected as a vibration level of a sprung member of the vehicle. In this case, a vehicle body may be subjected to vibration of approximately 0.1 Hz at the time of steering, in addition to vibration with a sprung resonant frequency of 1 Hz to 2 Hz and vibration with an unsprung resonant frequency of 10 Hz to 20 Hz. Even in such a case where the sprung member is subjected to vibration of broad frequency bands from 0.1 Hz to 20 Hz, the present embodiment enables accurate detection of a vibration level of the sprung member regardless of the frequency.

Furthermore, in the present embodiment, the signal level (vibration level) is obtained using the vibration information of the mass M in a spring-mass system, in which the mass M is supported by the spring S, as a signal. However, the vibration level of the mass M can also be obtained using vibration information related to the rotation of the mass M as a signal.

Therefore, in the case where the vibration level, i.e., the signal level is obtained using the vibration information as a signal, the signal level detection device 1 is suitable not only for detection of the vibration levels of the sprung member and the unsprung member of the vehicle, but also for detection of the vibration level of a steering wheel, whose vibration frequency in the rotation direction varies to a great extent on a case-by-case basis depending on the condition of maneuver by a person on board.

In this case, it is possible to detect vibration information related to one of the rotation angle, angular velocity, and angular acceleration of the steering wheel as a signal, and obtain a vibration level related to the rotation of the steering wheel on the basis of one of the rotation angle, angular velocity, and angular acceleration.

As such, the signal level detection device 1 can, by itself, obtain a vibration level of a vibrating device in a vehicle affected by vibration in a broad frequency bandwidth. It is hence apparent that the signal level detection device 1 is most suitable for a vehicle. It is also possible to select a plurality of pieces of vibration information as signals, and obtain a vibration level for each piece of information by processing the pieces of information in one signal level detection device 1.

The signal level detection device and the signal level detection method according to the present embodiment are also suitable for a vehicle other than an automobile, such as a railway vehicle. Furthermore, they can be applied to detection of a vibration level of an architectural structure as well. They can also obtain a signal level by processing various types of signals output from a sensor and the like.

Embodiments of the present invention were described above, but the above embodiments are merely examples of applications of the present invention, and the technical scope of the present invention is not limited to the specific constitutions of the above embodiments.

With respect to the above description, the contents of application No. 2013-192086, with a filing date of Sep. 17, 2013 in Japan, are incorporated herein by reference.

1. A signal level detection device that detects a signal level representing a magnitude of a signal, the signal level detection device comprising:
a signal generation unit configured to generate a plurality of level calculation signals that are out of phase with one another by using an input original signal; and
a signal level computation unit configured to obtain the signal level based on the original signal and two or more of the level calculation signals, or based on three or more of the level calculation signals.

2. The signal level detection device according to claim 1, wherein
the signal level computation unit uses a maximum value among the original signal and the two or more level calculation signals, or a maximum value among the three or more level calculation signals, as the signal level.

3. The signal level detection device according to claim 1, wherein
the signal level computation unit applies absolute value processing to the original signal and the two or more level calculation signals, or to the three or more level calculation signals, and uses a maximum value among the original signal and the two or more level calculation signals that have been subjected to the absolute value processing, or a maximum value among the three or more level calculation signals that have been subjected to the absolute value processing, as the signal level.

4. The signal level detection device according to claim 1, wherein
the signal generation unit generates the level calculation signals that have the same amplitude as the original signal.

5. The signal level detection device according to claim 1, further comprising
a low-pass filter configured to filter the signal level obtained by the signal level computation unit.

6. The signal level detection device according to claim 1, wherein
the signal generation unit includes a plurality of phase shifting filters, and generates the level calculation signals that are out of phase with the original signal by processing the original signal using the phase shifting filters.

7. The signal level detection device according to claim 6, wherein
the plurality of phase shifting filters are arranged in parallel, and each of the plurality of phase shifting filters generates a corresponding one of the level calculation signals.

8. The signal level detection device according to claim 6, wherein
the plurality of phase shifting filters are arranged in series, and each of the plurality of phase shifting filters generates a corresponding one of the level calculation signals.

9. The signal level detection device according to claim 6, wherein
provided that a Laplace operator is s and frequency is co, a transfer function G(s) of the phase shifting filters is set in accordance with an expression (1) or an expression (2), and
the signal generation unit generates the level calculation signals from the original signal while changing a value of the frequency ω for each one of the level calculation signals to be generated.
$$\begin{matrix}[ Math 1 ] & \\ G ( s ) = \frac{- s + ω}{s + ω} & ( 1 ) \\ [ Math 2 ] & \\ G ( s ) = \frac{s - ω}{s + ω} & ( 2 )\end{matrix}$$

10. The signal level detection device according to claim 1, wherein
among the plurality of level calculation signals, the two or more level calculation signals contributing to detection of the signal level are generated such that phase differences among the original signal and the two or more level calculation signals are represented by an equal interval within a 180-degree phase range.

11. The signal level detection device according to claim 1, wherein
among the plurality of level calculation signals, the three or more level calculation signals contributing to detection of the signal level are generated such that phase differences thereamong are represented by an equal interval within a 180-degree phase range.

12. The signal level detection device according to claim 10, wherein
the phase differences are equal to or smaller than 60 degrees.

13. The signal level detection device according to claim 11, wherein
the phase differences are equal to or smaller than 60 degrees.

14. The signal level detection device according to claim 1, wherein
the signal is one or more signals that are arbitrarily selected from among a displacement, a velocity, an acceleration, a rotation angle, an angular velocity, and an angular acceleration.

15. A signal level detection method for detecting a signal level representing a magnitude of a signal, the signal level detection method comprising:
generating, from an original signal, a plurality of level calculation signals that are out of phase with one another; and
obtaining the signal level based on the original signal and the plurality of level calculation signals, or based on the plurality of level calculation signals.

16. The signal level detection method according to claim 15, wherein
a maximum value among the original signal and two or more of the level calculation signals, or a maximum value among three or more of the level calculation signals, is obtained as the signal level.
